(19) United States
(12) Patent Application Publication
(10) Pub. No.: US 2013/0325742 A1
(43) Pub. Date: Dec. 5, 2013

(54) DATA STORAGE METHODS

(71) Applicants: Jon Asay, Fruit Heights, UT (US); Thomas Brenna, Bountiful, UT (US)

(72) Inventors: Jon Asay, Fruit Heights, UT (US); Thomas Brenna, Bountiful, UT (US)

(73) Assignee: Northwest Research, Inc., Salt Lake City, UT (US)

(21) Appl. No.: 13/608,983

(22) Filed: Sep. 10, 2012

Related U.S. Application Data
(63) Continuation of application No. 13/608,763, filed on Sep. 10, 2012.
(60) Provisional application No. 61/654,719, filed on Jun. 1, 2012.
(60) Provisional application No. 61/658,327, filed on Jun. 11, 2012.

(51) Int. Cl. G06Q 10/08

(52) U.S. Cl. CPC G06Q 10/083
USPC 705/337

(57) ABSTRACT

The processing of data and inventory, particularly with regards to packages having an issue affecting their delivery, is disclosed. Among other things, embodiments of the present disclosure help enable the quick, efficient, and accurate resolution to such issues. According to various embodiments, a method performed by a computer program operating on a computer system is disclosed, the method comprising: storing, by the computer system, a first record in a database in communication with the computer system, the first record including a first key associated with the first record, and a second key associated with a second record stored in the database; updating, by the computer system, an entry in an index table, wherein the entry includes the second key associated with the second record, and updating the entry includes adding at least a portion of the first key to the entry.

### CROSS REFERENCE TO RELATED APPLICATION

This application is a continuation of and claims priority to U.S. patent application Ser. No. 13/608,763, filed on Sep. 10, 2012, and claims priority to U.S. Provisional Patent Application Ser. No. 61/654,719, filed on Jun. 1, 2012 and U.S. Provisional Patent Application Ser. No. 61/658,327, filed on Jun. 11, 2012, the disclosures of which are incorporated by reference in their entirety for all purposes.

### BACKGROUND

Embodiments of the present disclosure are directed to systems and methods for inventory management, and more particularly to the processing of packages.

Of the large number of packages shipped worldwide each year, a portion encounter one or more issues during delivery. Such issues include incorrect or missing labels, errors in sorting, mishandling, damage to the package or its contents, refusal of the package by the recipient, and other problems. Packages having such issues may be referred to herein as “problem packages.”

When such issues occur, the problems should be addressed, regardless of the value of the package, by shippers or their partners since the shippers are ultimately responsible for the package until it is properly delivered, or the error in delivery is appropriately addressed. Depending on the nature of the issue, conventional methods for addressing such issues can often be time consuming, labor intensive, prone to error, and/or expensive.

Additionally, shippers often contend with incomplete or incorrect information regarding problem packages. This, combined with the large volume of packages handled by a shipper, can make matching a problem package to its intended recipient even more difficult. Embodiments of the present disclosure help resolve such issues in an efficient and cost-effective manner when they arise.

### SUMMARY

Embodiments of the present disclosure variously address the processing of data and inventory, particularly with regards to packages having an issue affecting their delivery. Among other things, embodiments of the present disclosure help enable the quick, efficient, and accurate resolution to such issues.

According to various embodiments, a method performed by a computer program operating on a computer system is disclosed, the method comprising: storing, by the computer system, a first record in a database in communication with the computer system, the first record including a first key associated with the first record, and a second key associated with a second record stored in the database; updating, by the computer system, an entry in an index table, wherein the entry includes the second key associated with the second record, and updating the entry includes adding at least a portion of the first key to the entry.

According to various embodiments, a tangible non-transitory computer-readable medium has instructions stored thereon, that, in response to execution by a processor, cause the processor to perform operations comprising: storing a first record in a database in communication with the computer system, the first record including a first key associated with the first record, and a second key associated with a second record stored in the database; updating an entry in an index table, wherein the entry includes the second key associated with the second record, and updating the entry includes adding at least a portion of the first key to the entry.

According to various embodiments, a system comprises: a database; and a computer system in communication with the database, the computer system comprising: a processor; and a tangible, non-transitory memory coupled to the processor and storing instructions that, in response to execution by the processor, cause the processor to perform operations comprising: storing a first record in the database, the first record including a first key associated with the first record, and a second key associated with a second record stored in the database; updating an entry in an index table, wherein the entry includes the second key associated with the second record, and updating the entry includes adding at least a portion of the first key to the entry.

Both the foregoing summary and the following detailed description are exemplary and explanatory only and are not restrictive of the present disclosure.

### BRIEF DESCRIPTION OF THE DRAWINGS

A more complete understanding of the embodiments of the present disclosure may be derived by referring to the detailed description and claims when considered in connection with the following illustrative figures.

FIG. 1 illustrates an exemplary system according to various embodiments of the present disclosure.

FIGS. 2-7 are flow diagrams illustrating exemplary processes according to various embodiments of the present disclosure.

### DETAILED DESCRIPTION

The detailed description of exemplary embodiments herein makes reference to the accompanying figures, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties.

Systems, methods and computer program products are provided. In the detailed description herein, references to “one embodiment”, “an embodiment”, “an exemplary embodiment”, etc., indicate that the embodiment described may include a particular feature, structure, or characteristic, but it is not necessary that every embodiment include the particular feature, structure, or characteristic. Moreover, such phrases do not necessarily refer to the same embodiment. When a particular feature, structure, or characteristic is described in connection with an embodiment, it is submitted that it is within the knowledge of one skilled in the art to implement such feature, structure, or characteristic in connection with other embodiments whether or not explicitly described.

When components are described as being “in communication” with each other in the detailed description or claims, such components may be in communication with each other constantly or periodically. Additionally, components in various embodiments may be in communication with each other via any suitable form of communication medium, use any suitable form of communication format, may be electrically coupled, physically coupled, and/or in communication with each other wirelessly.

In various embodiments, the methods described herein are implemented using the various particular machines described herein, and those later developed, in any suitable combination. The methods described herein may result in various transformations of certain articles. The disclosure may be implemented in conjunction with a method, system and/or a computer readable medium.

Exemplary System

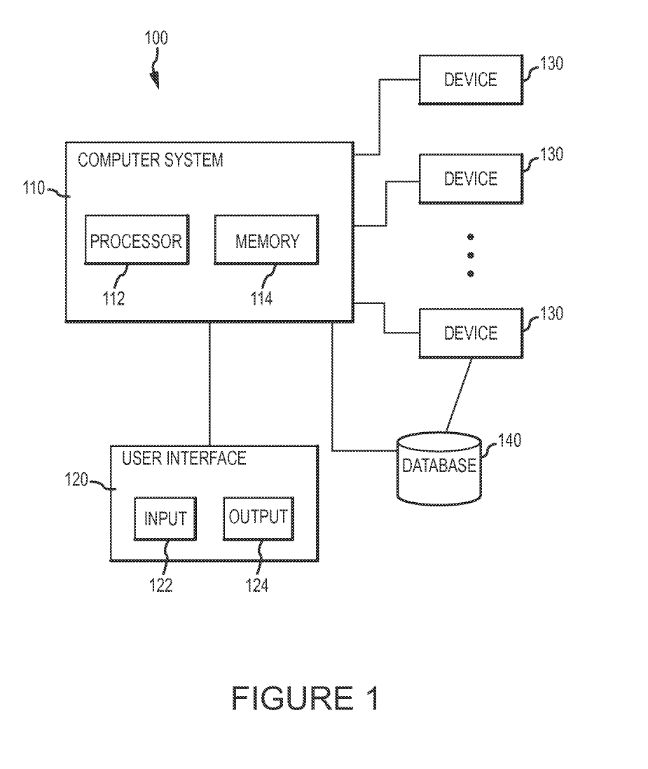

Turning now to the Figures, where the purpose is to describe exemplary embodiments of the present disclosure and not to limit same, an exemplary system 100 is depicted in FIG. 1. In various embodiments, the system 100 includes a computer system 110 comprising a processor 112 and a memory 115. Computer system 110 is in communication with a user interface 120, which includes an input device 122, and output device 124. Computer system 110 is further in communication with multiple external devices 130, as well as a database 140. System 100 may be implemented in a facility for tracking and shipping packages, and may be one of a plurality of such systems operating together, or separately, to identify problem packages, and match and/or ship them to an appropriate recipient. Such stations may share any of the devices or resources shown in FIG. 1.

In various embodiments, and as shown in FIG. 1, computer system 110 may store a software program configured to perform the methods described herein in the memory 115, and run the software program using the processor 112. The computer system 110 may include any number of individual processors 112 and memories 115. Various data may be communicated between the computer system 110 and a user via the user interface 120. Such information may also be communicated between the computer system 110 and the external devices 130, database 140, and/or any other computing device connected to the computer system 110 (e.g., through a local area network (LAN), or wide area network (WAN) such as the Internet).

In the exemplary system 100 depicted in FIG. 1, the processor 112 retrieves and executes instructions stored in the memory 115 to control the operation of the computer system 110. Any number and type of processor(s) such as an integrated circuit microprocessor, microcontroller, and/or digital signal processor (DSP), can be used in conjunction with the embodiments described in the present disclosure. The processor 112 may include, or operate in conjunction with, any other suitable components and features, such as comparators, analog-to-digital converters (ADCs), and/or digital-to-analog converters (DACs). Functionality of embodiments of the present disclosure may also be implemented through various hardware components storing machine-readable instructions, such as application-specific integrated circuits (ASICs), field-programmable gate arrays (FPGAs) and/or complex programmable logic devices (CPLDs).

The memory 115 may include a non-transitory computer-readable medium (such as on a CD-ROM, DVD-ROM, hard drive or FLASH memory) storing computer-readable instructions stored thereon that can be executed by the processor 112 to perform the methods of the present disclosure. The memory 115 may include any combination of different memory storage devices, such as hard drives, random access memory (RAM), read only memory (ROM), FLASH memory, or any other type of volatile and/or nonvolatile memory.

The computer system 110 may receive and display information (such as information related to problem packages) via the user interface 120. The user interface 120 (and the user interfaces of any external devices 130 used in conjunction with embodiments of the present disclosure) may include various peripheral output devices 124 (such as monitors and printers), as well as any suitable input or control devices 122 (such as a mouse and keyboard) to allow users to control and interact with the software program. In some embodiments, the user interface 120 may include multiple printers variously configured to print shipping labels of different sizes, formats, and/or from different shippers.

The user interface 120 may include any number of components, devices, and/or systems, such as speakers, an external memory device, a touch pad, a touch screen, and/or an alphanumeric keypad to allow a user to enter instructions, data related to problem packages, and other input. The user interface 120 may also include a microphone to allow a user to provide audio input, as well as a camera to allow the user to capture still or video images of a package being analyzed. Any of the components of the user interface 120 may be utilized as external devices 130 as described below.

The user interface of any component operating in conjunction with embodiments of the present disclosure may include, or operate with, audio or speech recognition software to process and analyze audio or verbal input through the user interface, as well as pattern recognition software to analyze graphics, text, and video received through the user interface 120, from the external devices 130, or from any other source.

The computer system 110 may communicate with any number of devices 130. In some embodiments, one or more devices 130 are configured to obtain information regarding a package and provide the information to the computer system 110 through a wired or wireless connection. Devices 130 may also communicate directly with the database 140, each other, or with any other system or device operating in conjunction with the embodiments described herein.

Packages typically include a barcode or information in another electronically-readable format printed on, or associated with the package or a label affixed to the package to provide information about the package. In some cases, a radio frequency identification (RFID) tag may be attached to the package or its labeling to provide such information. Accordingly, embodiments of the present disclosure may operate in conjunction with a device 130 that includes a handheld scanner (e.g., a barcode scanner and/or RFID reader) for reading such information and communicating it to the computer system 110, database 140, or other system. Such scanners may communicate with the computer system 110 or other device through a wired connection, such as a universal serial bus (USB) connection, a computer network connection, a mobile device synchronization port connection, a power connection, and/or a security cable. Such scanners may also communicate with any device operating in conjunction with an embodiment of the present disclosure through any desired wireless connection, such as a wireless Internet connection, a cellular telephone network connection, a wireless LAN connection, a wireless WAN connection, and/or an optical connection. Various embodiments of the present disclosure may include, or operate in conjunction with, any other type of scanner or similar device.

Embodiments of the present disclosure may operate in conjunction with any other type of device 130. In some embodiments, a device 130 may include a scale for measuring the weight of a package, one or more cameras for providing images of a package, as well as ultrasound or x-ray scanning devices for identifying the contents of a package without opening it. The device 130 may also include a chemical detector, such as a gas chromatography detector, to (for example) identify potentially harmful contents of a package or contents that may have ruptured, allowing a user of the computer system 110 to flag the package for special handling or disposal.

The device 130 may also include an electronic dimension measurement system to automatically measure the height, length, and/or depth of a package. In some embodiments, multiple measurement systems may be combined or used together to automatically determine information and characteristics of a package and store such information in the database 140 with little or no user interaction. Among other things, this helps ensure information for a package is not only gathered quickly and completely, but that is accurate and free from human-introduced errors that may occur from manually entering such information.

The database 140 stores and provides information related to packages, as well as any other desired information. The database 140 may be implemented on computer system 110 or hosted by another system or device (such as a server) in communication with the computer system 100 via, for example, a network such as a LAN or WAN. In some embodiments, database 140 is implemented as a relational database and includes records having information on a package, its shipping history, its location within a storage or processing facility, the user(s) assigned to processing or analyzing the package, and other information as discussed in more detail below.

The computer system 110 may include, or operate in conjunction with, any type of computing device, such as a laptop computer, a desktop computer, a mobile subscriber communication device, a mobile phone, a personal digital assistant (PDA), a tablet computer, a digital camera, a video camera, a video game console, and/or a media player.

The computer system 110 and other computing devices operating in conjunction with embodiments of the present disclosure may include an operating system (e.g., Windows, OS2, UNIX, Linux, Solaris, MacOS, etc.) as well as various conventional support software and drivers typically associated with computers. Software applications stored in the memory of such devices may be entirely or partially served or executed by the processor(s) in performing methods or processes of the present disclosure.

Any of the components in FIG. 1, as well as other systems and components operating with, or as part of, embodiments of the present disclosure may communicate with each other via a network (not shown). In some embodiments, one or more components of system 100 may include a wireless transceiver and the network may comprise a wireless system to allow wireless communication between various systems and devices, such as a wireless mobile telephony network, General Packet Radio Service (GPRS) network, wireless Local Area Network (WLAN), Global System for Mobile Communications (GSM) network, Personal Communication Service (PCS) network, Advanced Mobile Phone System (AMPS) network, and/or a satellite communication network. Such networks may be configured to facilitate communication via any other type of connection, such as a wired Internet connection, a wireless Internet connection, a cellular telephone network connection, a wireless LAN connection, a wireless WAN connection, an optical connection, a USB connection, and/or a mobile device synchronization port connection.

Exemplary Methods

The methods described below may be implemented in any manner, such as through a software program operating on a computer-based system. Such a software program may be stored on any computer-readable medium, such as floppy disks, hard disks, CD-ROMs, DVDs, any type of optical or magneti-optical disks, volatile or non-volatile memory, and/or any other type of media suitable for storing electronic instructions and capable of interfacing with a computing device. Methods according to embodiments of present disclosure may operate in conjunction with any type of computer system, such as a personal computer (PC), server, cellular phone, personal digital assistant (PDA), portable computer (such as a laptop), embedded computing system, and/or any other type of computing device. The computer system may include any number of computing devices connected in any manner, such as through a distributed network. The computer system may communicate and/or interface with any number of users and/or other computing devices to send and receive any suitable information in any manner, such as via a local area network (LAN), cellular communication, radio, satellite transmission, a modem, the Internet, and/or the like.

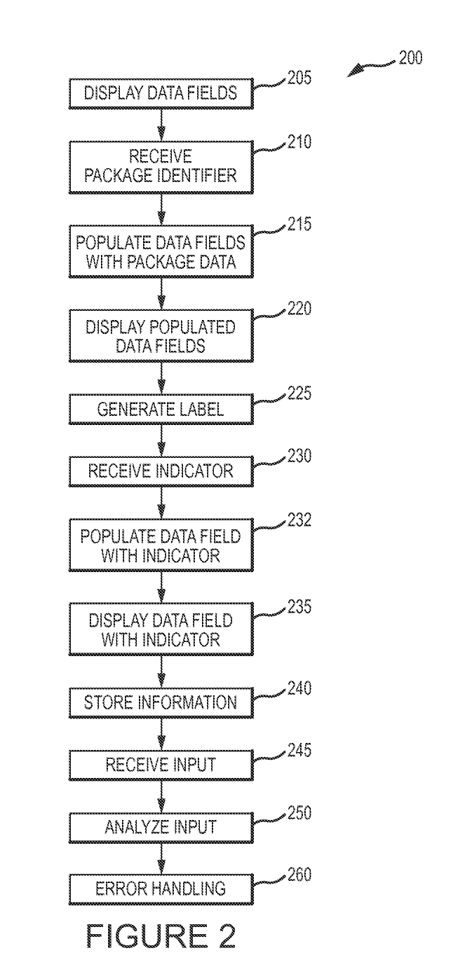

FIG. 2 depicts an exemplary method according to various aspects of the present disclosure, and may be used with any suitable system, including the system 100 depicted in FIG. 1. The method in FIG. 2 may be practiced with more, fewer, or different steps in conjunction with various embodiments of this disclosure, and may be performed by hardware, software, or a combination of the two as described above. The steps in FIG. 2, as with the steps in the methods shown in the other figures may be combined with each other in any suitable order in accordance with various embodiments of the present disclosure.

As shown in FIG. 2, exemplary method 200 includes displaying, on a display screen, a plurality of data fields related to shipping a package (205), and receiving an identifier for a package (210). In response to receiving the identifier, method 200 also includes automatically populating a data field with data for the package from a device (215) and displaying the populated data field on the display screen (220). Method 200 additionally includes generating a shipping label for the package that includes the identifier and/or the data from the device (225). Method 200 further includes receiving an indicator characterizing the identifier (230), populating a data field with the indicator (232) and displaying the data field with the indicator on the display screen (235), as well as storing data from the device (240), receiving input from a user via a user interface (245), analyzing the input and identifying an error (250), and performing an error handling procedure (260).

In exemplary embodiments of the present disclosure, data related to shipping a package, such as the name and address of the addressor, the name and address of the addressee, the identity of the shipper(s) handling the package, and other information can be stored in a relational database keyed to one or more identifiers for the package. In many cases the identifier is an alphanumeric code printed on a shipping label, and encoded in a bar code, RFID tag or in another electronically-readable format or medium.

A package having a shipping issue may be addressed by a user utilizing a system (such as system 100 shown in FIG. 1), wherein the user is provided, on a display screen, a plurality of data fields related to shipping the package (205). These fields may include information for the addressor, addressee, shipper, the contents of the package, characteristics for the package (such as its packaging color, the type of packaging used, the dimensions of the package, the package's weight, its volume, etc.) and any other desired information.

The computer system displaying the fields receives the package's identifier (210), and populates and displays data from a device (such as external device 130) in response (215), (220). The identifier can be received by the computer system displaying the data in any suitable manner. For example, the user may utilize a device 130 that includes a hand-held scanner for reading barcodes and/or RFID tags to read the identifier from the package and provide it to the computer system. Alternately, the identifier may be provided electronically from another device, read from a database 140 in communication with the computer system 110, or manually entered by the user via the user interface 120.

In response to receiving the identifier, a data field is automatically populated with data from a device in communication with the computer system (such as device 130) (215) and the field displayed (220) via the user interface 120. In some embodiments, the computer system may receive the data from the external device 130 or other system before the identifier is received, and queue the information until it can be associated with the identifier. In one exemplary embodiment, the external device 130 includes a scale, and the weight of the package is provided to the computer system 110 as soon as the package is placed on the scale. Embodiments of the present disclosure may receive multiple identifiers for a package, as well as data from multiple external devices 130.

In some embodiments, the computer system 110 may automatically retrieve the data from the external device 130 in response to receiving the identifier. In other embodiments, the data from the device 130 may be displayed on the screen prior to the identifier being received. As described in more detail below, the identifier or other data for the package may be used to retrieve a database entry in the database 140 in order to perform further analysis and processing of the package. Likewise, data for the package can be stored in one or more records in the database 140.

Data regarding a package can be received or retrieved from any source, including device 130, database 140, or any other system or device operating in conjunction with embodiments of the present disclosure. For example, data such as the dimensions for a package may be automatically received from a device 130 including an electronic measurement system in communication with computer system 110, scanned from the label on the package, retrieved from a database entry associated with the package in the database 140, automatically parsed from an electronic communication (e.g., email, text message, voice mail), and/or manually entered by a user of the computer system 110 via the user interface 120.

A shipping label may generated (225) that includes the identifier for the package and/or the data received from the device 130. The shipping label may also include any other information related to the package, such as information regarding why the package had a delivery issue, a priority level for the package, special handling instructions for the package, the package's current location, an indicator characterizing the identifier (see step 230 below), and/or any other desired information. Steps 205-225 allow a user (such as a member of a warehouse crew responsible for shipping the package) to quickly, accurately, and efficiently prepare a package for shipment.

Method 200 further includes receiving an indicator characterizing the identifier (230), populating a data field with the indicator (232), and displaying the populated data field on the display screen (235). Embodiments of the present disclosure may utilize any indicator related to the identifier, such as an indicator that the identifier is an original identifier for the package; an indicator that the identifier is modified from an original identifier for the package; an indicator that the identifier is associated with a shipment of other packages; and/or an indicator having a second identifier associated with the package. Among other things, the indicator allows users/researchers of embodiments of the present disclosure to further classify problem packages, identify the source of their shipping issue, and arrive at a solution for handling the package more effectively and efficiently than by analyzing the identifier alone.

Method 200 further includes storing data from the device 130 in a memory (240). The data may be stored in any memory and in any format. In some embodiments, the data from the device is stored in a database record associated with the package in database 140. Additionally or alternatively, the data may be stored in a file stored in the memory 114 of the computer system 110 or other system operating in conjunction with system 100. Storage of the data from the devices 130 helps build a comprehensive data set for a problem package that can be accessed by multiple users/researchers (in different locations if desired) without requiring redundant investigation or data entry.

The delivery issues for many packages often stem from incorrect information. For example, the name or address of the addressee may be incorrectly printed on the shipping label for a package, or the tracking/identification number for the package is incorrect on the label or elsewhere in a shipper's system. Embodiments of the present disclosure can provide sophisticated and intelligent error detection and correction techniques to help identify such errors and prevent users from reinforcing existing errors or introducing new ones.

Referring again to FIG. 2, method 200 includes receiving input from a user via an input device 122 of a user interface 120 (245), analyzing the input to identify an error associated with the input (250), and performing an error handling process (260). FIG. 2A illustrates exemplary error correction steps that may be taken individually or together. For example, in response to an error associated with a user's input being identified, a communication can be automatically displayed on the user's display screen (262). Preferably, the communication includes a description of the error as well as a description of a course of action for the user to take to correct the error, although the alert may include any other desired information.

Additionally, the user can be blocked from further input until he/she fixes the error (264), preventing the error from being forgotten and introduced to the system (e.g., by being saved into a record associated with the package into the database 140). Instead of requiring the user to fix the error, the system may correct the error (266). Automatic correction of errors can be particularly effective when the system's analysis indicates there is only one correct course of action possible. If more than one correct option is possible, the system can alternatively display a list of possible correct choices for the user to select from via the user interface 120.

In some embodiments, analysis of the input from a user (250) may include comparing the user's input to a rule set. Such rule sets may be defined in terms of actions allowed (i.e., whitelisting), disallowed (i.e. blacklisting), or a combination of the two. For example, an exemplary rule set may include rules to be enforced when different users or groups of users attempt to add packages to groups of packages to be shipped, rules for how the profile of a package or group of packages can be modified, or for any other desired situation or event. Such rule sets help prevent packages being lost due to a package being improperly assigned to the wrong group, and help to identify erroneous input from users (264) before such input can have be saved in a database and propagated through the system.

The following enumerated list illustrates a set of exemplary rules that may be implemented (e.g., via software) in conjunction with embodiments of the present disclosure to define how various attributes of a package can be changed. In this example, “PR” means Package Rebound Profile. A “PR” attribute indicates that delivery of the package was unsuccessful and it is to be “rebounded” back to the shipper using a special set of rules defined by the shipper or the shipper's agent. These rules and the data identifying the customer (e.g., address, phone, company name, etc.) make up the “Profile”. In this example, the attribute of the package to be altered (i.e., a field in a database record accessed by a user or by the computer system 110) is called “Package Set,” which refers to the group of packages the package is assigned to. “PR 1” is a Package Rebound Profile (i.e., “Package Rebound Customer #1”), while “PR 2” is a Package Rebound Profile for a second customer (i.e., “Package Rebound Customer #2”). These rules describe the circumstances under which packages associated to a profile may or may not be associated with Package Sets associated to the same or other profiles.

1) Package is associated to PR 1, adding package to Package Set associated to PR 1 is allowed.

2) Package is associated to PR 2, adding package to Package Set associated to PR 1 is NOT allowed.

3) Package is not PR (i.e., not associated with any rebound profile), adding package to Package Set associated to PR1 is NOT allowed.

4) Package is not associated to any PR, adding package to a Package Set that is not associated to any PR is allowed.

5) Package is associated to PR 1, adding package to Package Set that is not associated to any PR is allowed.

6) Package set is associated to PR 1 and has 2 packages assigned to it as PR1. Attempt to change Package Set to be associated with PR 2 is NOT allowed.

7) Package set is not associated to PR and has 2 packages assigned as no PR. Attempt to change Package Set to be associated with PR1 is NOT allowed.

8) Package set is PR1 and has 2 packages assigned to it as PR1. Attempt to change Package Set to not PR is allowed.

9) Package set is not PR and has 2 packages assigned to it as PR1. Attempt to associate Package Set to PR1 is allowed.

10) Package set is not PR and has 2 packages assigned to it, a first package as PR1 and a second as PR2. Attempt to change Package Set to PR1 is NOT allowed.

11) Package set is PR1 and has a package that is PR1. Attempt to change package to PR2 is NOT allowed.

12) Package set is PR1 and has a package that is PR1. Attempt to change package to not PR is NOT allowed.

13) Package set is not PR and has a package that is PR1. Attempt to change package to PR2 is allowed.

14) Package set is not PR and has a package that is PR1. Attempt to change package to not PR is allowed.

15) Package set is not PR and package is not PR. Attempt to change package to PR1 is allowed.

In some embodiments, the communication may include a link (e.g., a hyperlink to a page on an intranet or the Internet, a link to a text or video file, and/or a link that opens up a separate window) to training materials (268) related to the error to allow the user to learn more about the nature of the error and how to prevent it in the future. Embodiments of the present disclosure may also initiate contact with another user in response to identifying the error (270), such as by initiating a telephone communication, an email, a text message, a visual indicator (e.g., a flashing alert on a supervisor's computer or illuminating a light above the user's station indicating he/she needs assistance), and/or an audible indicator (e.g., a tone initiated through the supervisor's computer or over a speaker in communication with the user's computer system). In some embodiments, a chat window can automatically be opened on the user's display screen to connect the user to a support person. Such communications can automatically be routed to support personnel not occupied with other matters so that the user can obtain help as quickly as possible.

In response to identifying the error, some embodiments may create a log (272) related to the error. In some embodiments, the log is stored in a database (such as database 140) and includes an identifier associated with the user (such as the user's name or employee number). Using such logs, a report may be created (274) that includes information from the log and provided (276) to another user (or group of users) via an electronic communication (e.g., automated phone call, voicemail, email, text message, and/or displayed on the second user's computer system in response to the second user accessing a file containing the report). The logged error can further be compared to previously-logged errors (278) associated with a user or group of users, and an alert generated in response to the comparison (280). The alert may be provided to any number of users by electronic communication in the same manner or in a different manner than the report as described above.

Alerts may be generated, for example, based on the total number of errors committed by a user, a number of errors occurring for the user within a predetermined period of time, a severity level associated with any of the user's errors, a number of similar errors committed by the user, and/or any other desired criteria. Among other things, this allows another user (such as a supervisor or administrator), to assist the user, block the user from further use of the system, and/or schedule additional training for the user, thereby proactively addressing issues proximate to their occurrence and preventing series of errors from being propagated through the system.

Embodiments of the present disclosure help match problem packages with their appropriate recipients efficiently and accurately. In some cases, however, the intended recipient of a package refuses (for various reasons) receipt of the package. While such returns cause a “special case” that can be difficult, time-consuming, and error-prone for conventional shipping processes to handle, embodiments of the present disclosure help address such occurrences in an efficient, effective manner.

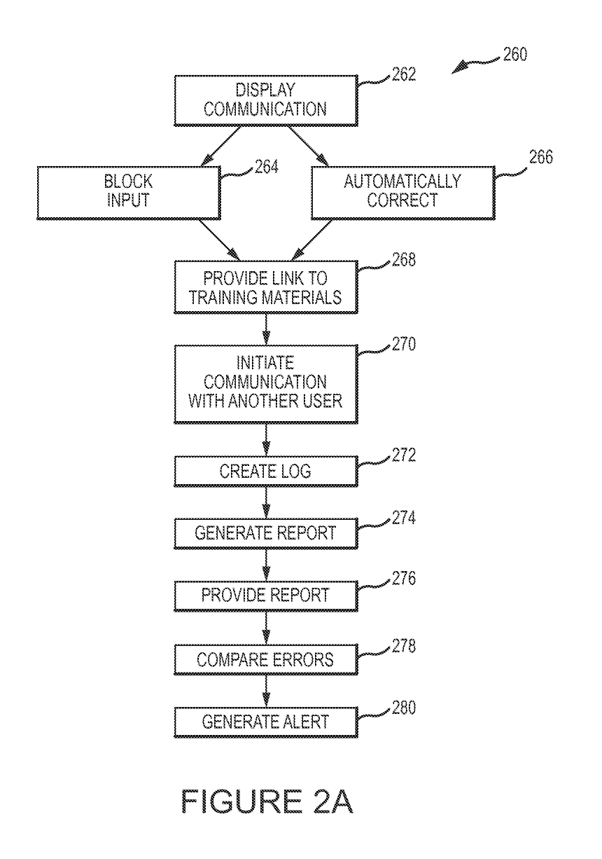

Referring now to FIG. 3, exemplary method 300 includes receiving an identifier for a package (305), and automatically retrieving a database entry associated with the package in response to receipt of the identifier (310). The method further includes determining, based on the information in the retrieved database entry, that the package was refused by its intended recipient (315), and automatically modifying a status field of the database entry to indicate the package was refused (320). Method 300 also includes automatically modifying a field in the database entry regarding further delivery for the package (325), identifying a shipper who shipped the package to the refusing recipient (330), retrieving a rule set associate with the shipper (335), and generating a shipping label in accordance with the rule set (340). Method 300 additionally includes automatically opening a search window for performing a search of the database (345), and populating data fields within the search window with information from the database entry (350).

In exemplary embodiments, an identifier for a package can be received (305) in any desired manner. For example, in embodiments operating in conjunction with system 100 from FIG. 1, a user may utilize a device 130 that includes a hand-held scanner for reading barcodes and/or RFID tags to read the identifier from the package and provide it to the computer system 110. Alternately, the identifier may be provided electronically from another device, read from a database 140 in communication with the computer system 110, or manually entered by the user via a user interface 120 in communication with the computer system 110.

In method 300, the received identifier may be associated with a package, and a database entry associated with the package retrieved (310) from a database. The database entry may be in any format, contain any desired information, and may be stored in any database, or across multiple databases. With reference to exemplary system 100, a database entry associated with the package may be retrieved from database 140 in communication with computer system 110. The database entry may be retrieved automatically in response to receipt of the identifier for the package (or in response to another event), or it may be retrieved semi-automatically or manually based on input from a user.

Software operating on a computer system (such as computer system 110) may be configured to analyze the retrieved database entry to determine whether the package associated with the entry was previously refused by an intended recipient (315), and a field in the retrieved database entry modified to indicate the package was refused (320).

In some embodiments, the field in the database entry that is modified to indicate the package was refused may include data, a link to another entry in the database, or other information explicitly indicating that the package was refused. In other embodiments, the database entry may already include information explicitly indicating that the package was refused. In such cases, this information may be accessed from the existing field, or the information may be copied (in whole or in part, verbatim or with modification) to another field to indicate the package was refused. The field may be modified automatically by a computer system, or semi-automatically or manually in response to input from a user.

Other embodiments may be configured to analyze the information in the database entry to determine whether the package was refused. For example, some embodiments may determine that the package was refused by the recipient where the name and address for the intended recipient is correct and the package was sent out to the recipient at the correct address, but the package is back at the shipping facility without any other problem noted in the shipping history. Embodiments of the present disclosure may determine that the package was refused according to any other desired criteria.

Embodiments of the present disclosure may be configured to analyze a database record (or multiple records) pertaining to multiple deliveries (or attempted deliveries) of the package to the refusing recipient. Such determinations may be used to, for example, determine how the package is handled subsequently, as discussed for step (325) below. Additionally, embodiments of the disclosure may be configured to retrieve database entries relating to other deliveries to the same or similar refusing recipient. Among other things, this can help identify errors in the shipping information (e.g., that an address used by a shipper to the recipient for multiple packages on multiple occasions is incorrect) as well as to identify acts of fraud (e.g., a thief attempting to use an unsuspecting recipient's address to receive goods ordered via a stolen credit card), as well as to help ensure packages are delivered correctly to recipients in the future, or for any other desired purpose.

Method 300 further includes modifying a field in the database entry to indicate how the package should be further processed (325). In this context, further processing of the package may include, for example, attempting to re-deliver the package to the same recipient that refused it (or preventing such re-delivery); delivering the package to another entity, such as the shipper of the package or an alternate addressee; scheduling the package to be disposed of (such as being destroyed or sent to auction); placing the package in storage, and any other desired action.

A processing action to be taken for a package may be determined according to any desired criteria. In some embodiments, processing of a refused package may be based on a rule set for a particular shipper, a standardized rule set governing the number of times a package can be delivered and subsequently refused, or any other criteria.

In some embodiments, further processing of a package may include attempting to identify an alternate recipient for the package. In such cases, this processing may include identifying the entity that shipped the package to the refusing recipient (330), retrieving a rule set associated with the entity (335), and generating a shipping label for the package based on the rule set (340). In some embodiments, the shipper's information is stored in the same database entry as the rest of the information for the package, though such information may be stored in other database records or in other databases. Likewise, a rule set for a shipper may be stored in any desired database or database entry.

Some rule sets for a shipping entity may include shipping information (e.g., name and address) for a recipient to ship the package to. In this manner, shippers can designate a location or agent to receive refused packages. Alternately, such rule sets may include links (e.g., hyperlinks) to information for the alternate recipient, as well as rules for how the shipper wishes an alternate recipient to be identified, thereby giving shippers the flexibility to dynamically designate alternate recipients based on the geographical location or identity of the addressor or addressee, the characteristics of the package (e.g., its weight, size, or contents) or any other desired criteria.

The shipping label may be generated in any desired format, such as a format specified in the rule set. In exemplary embodiments utilizing systems such as system 100 in FIG. 1, the label may be automatically printed via an output device 124 of user interface 120 that comprises a printer, allowing the label to be quickly generated in response to an individual shipper's desired rule set. The steps of method 300, including generation of the label (340), allow embodiments of the present disclosure to quickly and accurately identify refused packages and determine how they should be processed, without requiring user intervention or incurring the delays and possibility of errors being introduced as a result of such manual processing.

In some embodiments, it may be desirable to perform further searching to identify a recipient for a package. In such cases, embodiments of the present disclosure may be configured to automatically open a search window on a display screen (345) and populate fields in the search window with data from the retrieved database entry (350).

In embodiments utilizing a system such as system 100 in FIG. 1, a search window may be opened using an output device 124 of user interface 120 that includes a display screen, the user interface 120 in communication with computer system 110 running a software program to implement the steps of method 300. The search window may allow a user to automatically or semi-automatically search the database 140 according to any desired data or criteria. In some embodiments, data fields in the search window are pre-populated (350) with data from the retrieved database entry to increase the speed and accuracy of the search. A user of the computer system 110 may then add, delete, or modify search terms from the search window (if desired) and initiate the search. Once an alternate recipient is identified, a shipping label may be automatically (or in response to input from the user) generated for that recipient in the same manner as described for step (340).

Among other things, this method provides improved processing and recordkeeping over conventional methods for handling returned packages. It may be applied to packages returned for reasons other than refusal by the recipient, such as a misdelivery, an erroneous address, an error in identifying the addressor or addressee, or any other issue. Compared to conventional methods, this method also helps to eliminate time-consuming and error-prone manual steps for handling a returned package, helps prevent the loss or misplacement of such packages, and helps to reduce the number of times such packages are physically moved.

For many shippers, particularly large shippers who each day handle millions of packages destined for locations all over the world, packages may become lost or misplaced for a variety of reasons. A lost or misplaced package may be worth a considerable amount, and the shipper or its agent may be responsible for this amount if the package cannot be found. Moreover, the loss of packages can seriously damage the reputation of the shipper and its goodwill with its customers. Embodiments of the present disclosure not only help to prevent packages from becoming lost, but can quickly identify and locate packages that may be misplaced or mishandled.

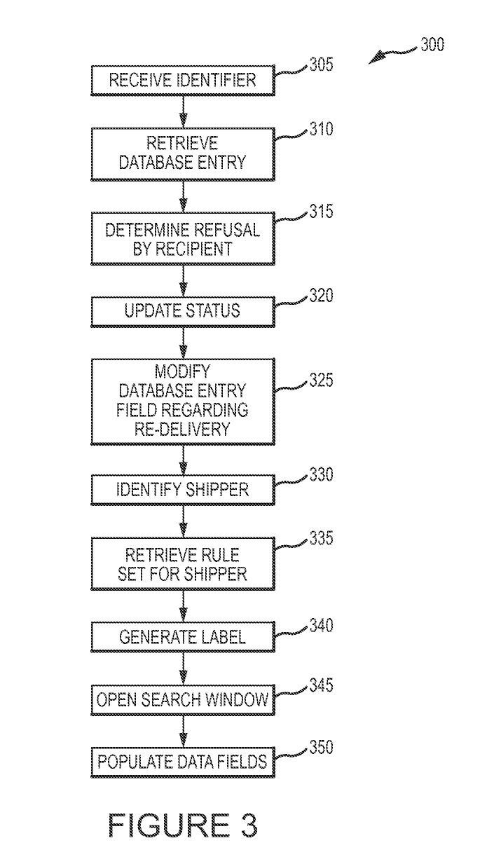

Referring now to FIG. 4, method 400 includes accessing a database having entries associated with packages to be matched with an intended recipient (405), identifying an entry from the database for which the package associated with the entry is unmatched to any recipient (410), and generating an alert that includes information for the unmatched package (415). Method 400 also includes displaying a list of unmatched packages (420), identifying one or more entries for matched packages (425), and displaying the matched packages in a list (430). Method 400 further includes receiving a selection of a matched package (435), updating the database entry corresponding to the selected package (440), generating a shipping label for the package (445), and removing the selected package from the list (450).

When packages encounter an issue during delivery, such as being lost, missorted, and/or misplaced, embodiments of the present disclosure may be configured to access a database (such as database 140) having entries associated with packages to be matched with an intended recipient (405). Such entries may be included in a single database or multiple databases, and the information regarding such packages may be stored in any desired format. Embodiments of the present disclosure may identify an entry associated with an unmatched package (410) in any suitable manner. For example, software operating on a computer system (such as system 110) may be configured to automatically search all or some of the package entries in a database for those entries having status fields indicating their respective packages are not matched with a recipient.

Various embodiments may be configured to analyze any other data related to a package, either in a single entry associated with the package or by analyzing multiple database records containing data related to a package, to determine if the package is matched or unmatched. For example, some embodiments may be configured to analyze a package's shipping history to determine that a package: was unsuccessfully delivered over a predetermined number of times; has been in storage for a predetermined period of time; is lacking information related to the addressor and/or addressee necessary to deliver; and/or any other information related to the package.

In the exemplary method depicted in FIG. 4, an alert is generated that includes information for the unmatched package(s) (415). The alert may include any desired information, may be delivered using any desired communications medium, and may be delivered to any number of recipients. In embodiments operating in conjunction with a computer system such as computer system 110 depicted in FIG. 1, an alert comprising a list of unmatched packages may be displayed via an output device 124 of user interface 120 that includes a display screen.

In some embodiments, the alert comprises a list of unmatched packages and is delivered via an electronic communication such as an email, web page, text message, or via the display screen of a user interface in communication with a computer system. The list may include any desired information regarding an unmatched package, such as an identifier for he package, its shipping history, its current location, and/or an identifier for an entity responsible for matching the package with its intended recipient. Such information may be provided in the list itself, or via links (e.g., hyperlinks) to entries in a database or a web page displaying such information. The list of package information may be dynamically sortable in response to input from a user via a user interface or automatically in accordance with a rule set accessible by a computer system providing the list. For example, the list may be configurable to display packages organized by ascending or descending identification number, by location, by an ascending or descending date associated with the package, or by any other field of the list.

The alert may be generated (415) immediately in response to finding any unmatched packages, or it may be generated in response to any desired conditions being met. For example, some embodiments may only generate the alert in response to a package being unmatched for at least a predetermined period of time.

The exemplary method 400 in FIG. 4 further includes identifying an entry associated with a package that has been matched to a recipient (425), and displaying information regarding the matched package in a list (430). Information for matched packages can be displayed in the same or a different list from the information for the unmatched packages, and may be displayed in any desired format. Information (e.g., matched vs. unmatched packages) may be provided in different lists or different sections of the same list. For example, a list of matched packages may be provided on a different page or selectable tab from unmatched packages. Likewise, such information could be divided by a visible divider or color coded to differentiate between matched and unmatched packages.

Any desired information related to matched or unmatched packages can be provided in an alert. In some embodiments, information displayed in an alert for a matched package may include a date the matched package was matched with its intended recipient, a date the package is to be shipped to its intended recipient, and/or a description of the package (e.g., its dimensions, color or other packaging description, and/or weight). Information in the alert for matched or unmatched packages may include one or more actions to be taken. For example, the alert may include instructions on where to find a matched or unmatched package in a warehouse, an indicator that the package should be shipped with a particular group of packages, and/or that the package should be rewrapped or relabeled prior to shipment.

Information for matched or unmatched packages in an alert (such as in a list) can be stored, copied, or manipulated in any other desired manner. In some embodiments, the alert may include links to web pages, files, and/or database entries to allow additional information related to a package to be accessed. Packages (and information related thereto) can be selected (435) (e.g., by a user via a user interface or in response to an electronic communication from another computer system) along with an indicator to perform an action with regards to the selected package. For example, a selection of a matched package in a list may be received in conjunction with an indication to ship the matched package.

In response to receipt of a selection for a package (435) or other event, a computer system implementing functionality of embodiments of the disclosure may be configured to update a database entry corresponding to the matched package (440) to, for example, indicate the package should be pulled from storage for shipping, and automatically generate a shipping label (445) for the package via a printer in communication with the computer system. Some embodiments may also be configured to add, modify, or delete information from an alert automatically or in response to input from a user. For example, a matched package that is selected and flagged for shipping can be removed from a list of matched packages pending shipment. Likewise, once an unmatched package has been matched, information for the package can be automatically removed (450) from a list of unmatched packages, thereby helping to ensure that users always have an up-to-date list of packages and their status to avoid unnecessary processing.

Embodiments of the present disclosure may be configured to provide different lists, reports, and other information to various individuals and systems, as well as groups of systems and individuals. In some embodiments, for example, groups of researchers may work independently or together to identify shipping issues for packages and prepare the packages for redelivery to the originally intended recipient (i.e., the addressee), the original sender (i.e., the addressor), the entity responsible for shipping the package, or another recipient. Groups of shipping personnel may likewise be working in conjunction with the researchers to handle incoming problem packages, route them to the researchers, and organize and store matched and unmatched packages pending a resolution to their shipping issues.

In such cases, embodiments of the present disclosure may be configured to prepare a customized report or other set of information based on an identified role for the recipient. Such recipients can be human users (such as researchers or shipping personnel) as well as other computer systems. Information sets may be prepared automatically by a computer system operating a software program, and can be configured by an operator (e.g., via a user interface or in response to a rule set). This not only simplifies the information provided to such personnel to help maximize their efficiency in processing their duties and managing their workflow, but also helps maintain the security of information related to addressors, addressees, shippers, and the packages themselves.

For example, a report sent to shipping personnel, accessed by computer systems in a shipping department, or retrieved by a user identified to be part of shipping personnel may include a subset of the total information available for a matched or unmatched package. Specifically, such information may include only the information necessary by the shipping personnel to handle and ship the package, while omitting information extraneous to the needs of the shipping personnel. Different sets of information can be provided to other types of users as well. For example, a researcher seeking to match a misdelivered package with its intended recipient may wish to see a complete shipping history for the package, while a shipping worker may only wish to see the name and address of the entity the package is to be shipped to next.

In some embodiments, such information can be provided to users via an interactive software application that provides, for example, shipping task lists, package information customized for the shipping department, and access to a subset of database search tools to allows shipping personnel to find information on packages they are responsible for handling or shipping. The application may be configured to allow users to select packages from a list for shipment together or separately, and to generate shipping labels for each package and/or shipment of packages.

Embodiments of the present disclosure may also be configured to automatically monitor the status of groups of packages and to add, modify, and remove information related to the packages from different lists as they progress through the shipping process. For example, in response to a group of packages being selected for shipment from a list of packages pending shipment, the selected packages may be automatically removed from the pending shipment list and added to a list of packages needing rewrapping. Similarly, once a package has shipped, it may be removed from the list of packages needing rewrapping and added to a list of packages pending delivery, along with tracking information for the package.

Embodiments of the present disclosure may provide information to different entities in different geographical locations, allowing researchers and shipping personnel in a plurality of shipping facilities to coordinate their activities and efficiently process packages. Some embodiments may also allow users to access any desired information based on the user's access level, job title, location, or other information, thereby providing the flexibility to access information not normally needed in the ordinary course of a group's operations.

Embodiments of the present disclosure may store, search, and retrieve data using any number of different databases, such as database 140 shown for system 100 in FIG. 1. Such databases may be hosted by computing devices (such as a server) and may communicate with each other and other computer systems (such as computer system 110) operating in conjunction with embodiments of the present disclosure via any suitable communication medium, including LANs and WANs. Some embodiments of the present disclosure utilize databases storing information in a relational format, though other embodiments may operate in conjunction with databases storing data in any other format (such as flat file formats).

Many large shippers handle millions of packages each day. As such, the amount of data associated with such large volumes of packages can often be difficult and time consuming to navigate in order to identify packages with shipping issues and resolve such issues in an efficient manner. In comparison to conventional methods for processing large data sets, embodiments of the present disclosure may be configured to provide efficient and effective methods for data storage, searching, and retrieval.

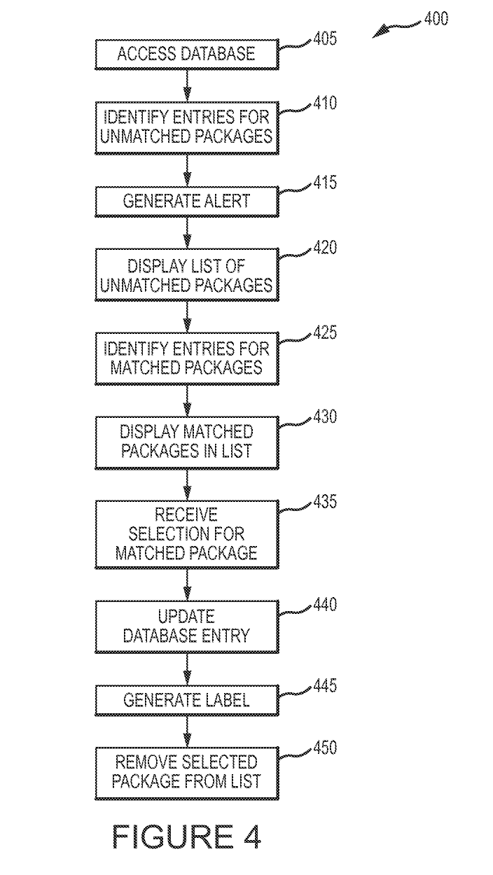

In many database applications, including those directed to helping to resolving issues with shipped packages, data may be stored in the database with multiple parent/child relationships between the various records. In such cases, data elements may be nested inside other data elements, and the parent/child relationships may be dynamically modified for some elements, forming, conceptually, a tree structure of data that can be multiple levels deep. Conventional methods for searching such databases typically require the recursive searching of all levels of the tree, which requires multiple search queries and can be extremely time consuming with large data sets. Referring now to FIG. 5, exemplary method 500 helps address these and other issues.

Method 500 includes storing a first record in a database (505) in a database. In some embodiments, the first record includes a first key associated with the first record, as well as a second key associated with a second record stored in the database. For example, the first record may be associated with a storage unit in a larger storage location within a facility for processing and storing problem packages. Such a facility may have multiple storage locations and multiple storage units, with and some storage locations contained within other storage locations, and with some storage units contained within other storage units. In some embodiments, a database entry describing a child storage location may include a foreign key to the database entry describing its parent location. This nested relationship of storage locations and storage units conceptually forms the tree structure discussed above. In this example, the first key may be associated with the storage unit itself (e.g., it may include an identifier for the storage unit), and the second key may be associated with the storage location where the storage unit is located (e.g., it may include an identifier for the storage location). The database may also store records associated with, for example, research or processing stations within the facility, as well as with a package or groups of packages (e.g., being transferred between facilities or shipped to another recipient). Keys associated with such records may thus include an identifier for a storage location, an identifier for a storage unit (e.g., within a storage location), an identifier for a package processing station (e.g., located at the same facility as a storage location), and/or an identifier for a package (e.g., stored in a storage unit).

In conjunction with storing the first database entry (505), method 500 includes updating an entry in an index table (510). The index table may be stored with, or separately from, the database it is associated with. Updating the entry may include modifying an existing entry or creating a new entry in the table, and may include adding some or all of a key to the entry. Alternately, the index table may contain other referencing information to help access a database record with which a key is associated.

In some embodiments, the entry includes multiple keys associated with respective multiple entries in the database. Continuing the previous example, an entry in the index table may include the second key associated with the second record (e.g., the storage location), and updating the entry may include adding the first key associated with the first record (e.g., the storage unit within the storage location). In this manner, a single entry in the index table includes keys to both the record for a storage location and a key to its storage unit. As additional storage units are added to the storage location, and a record for each storage location is added to the database, the entry in the index table can be updated to include the keys to each of the new units.

Method 500 further includes searching the index table (515) using at least a portion a key stored in the entry (e.g., at least a portion of the first key or the second key) and retrieving a record from the database (520). In some embodiments, the index table may be searched using some or all of multiple keys. Among other things, embodiments of the present disclosure allow a single database query (such as a “LIKE” operation for a SQL database) of the entry in the index table to quickly identify records for all storage units within the storage location, thus avoiding performing multiple queries on the database itself In the example discussed above, searching the index table using at least a portion of the second key (for the storage location) allows the first record (for the storage unit within the storage location) to be quickly retrieved using the modified entry in the index table, since all the storage units associated with the storage location are included in the same entry. Likewise, searching the index table using at least a portion of the first key allows the second record to be retrieved.

The index table may also be used to identify one or more packages located within a storage unit or storage location, or associated with any other records within the database. For example, method 500 also includes storing a third database record in the database (525). Continuing with the preceding example above, the third record may have a third key that includes an identifier for a package stored in the storage unit (the first record) within the storage location (the second record). Instead of having to perform an extensive search of every level of nesting in the database, however, the index table is updated (510), as with adding the first record, to include at least a portion of the third key in the entry. This allows all packages within a particular storage unit to be identified with just a single query (e.g., using a LIKE query in SQL). Similarly, all packages contained in a particular storage location can be found with a single query regardless of which storage unit within the location they are contained. In other words, a single query of the index table can find all packages in a storage location containing storage units nested within other storage units.

While embodiments of the present disclosure are particularly effective in aiding in package processing as described above, the techniques described herein may be applied to other industries and situations, particularly where nested data relationships are common. Embodiments of the present disclosure also allow database records and index table entries to be dynamically added, removed, or modified. For example, method 500 includes the steps of modifying a database record (530) and modifying an index table entry (535) to reflect the modification to the database record.

In some embodiments, storage units and/or storage locations may be moved, renamed, added, or deleted. Accordingly, embodiments of the present disclosure may be configured to automatically update the index table when such changes (or others) are made to records in the database and affect the reference data (e.g., keys) stored in the entries of the index table. In some embodiments, storage locations may be static once they are created, while storage units can be moved from one storage location to another, or added or deleted from a storage location. In such cases, embodiments of the present disclosure may modify a database record associated with a storage unit (530) and then modify an index table entry (535) accordingly. Multiple database records and/or index table entries may be modified as desired.

For example, if a storage unit moves, embodiments of the present disclosure may be configured to automatically generate new information for the index table entry associated with the storage unit. Additionally, the database records for all storage units contained within the moved storage unit can be updated using the index table (e.g., by using a LIKE SQL operation on the index table to find the records for the storage units within the moved unit) in a manner that applies the new location information to all nested storage units and preserves their relative positions within the moved storage unit.

In other instances, an identifier or other information within a database record may be changed. For example, an identifier for a storage unit may be edited to change the type of packages it stores. As described above, embodiments of the present disclosure may detect such changes and automatically update other database records and entries in the index table as appropriate. Similarly, embodiments may respond to the deletion of a storage unit record or other type of record by automatically deleting, from the index table, reference information associated with the deleted record. Updates to the database and/or index table may be performed synchronously (i.e., the update occurs before data is returned for a query) or asynchronously (i.e., the update is performed independent of any pending queries for data) as appropriate. Among other things, embodiments of the present disclosure can perform the appropriate updates to the database and index table to help ensure that the index table always properly reflects the state of storage locations, storage units, packages, and other data.

Embodiments of the present disclosure may be used to perform automated, semi-automated, or manual searches on various types of information across a large number of databases. With the large number of packages handled by major shippers each day, the volume of data in databases tracking such packages (and that must be searched to resolve the issues surrounding problem packages) grows very quickly. Due in part to the large amount of such data, researchers using conventional methods to search databases in an attempt to identify and process problem packages may receive a large number of incorrect, near-matches in response to their searches. These near-matches clutter the results of the database searches and often make it difficult to find the desired results. Additionally, many researchers may not have enough information, skill, or time to prepare an optimal set of search criteria for every search they perform. This further adds to the number of incorrect or extraneous results obtained.

Embodiments of the present disclosure address these and other issues by, among other things, automatically generating search criteria designed and optimized to exclude irrelevant and incorrect results. These searches can be stored and repeatedly performed (automatically or in response to user direction) without requiring a user to manually enter search criteria for every search.

Referring again to FIG. 5, method 500 includes the steps of analyzing data in the database (540) (such as data contained in one or more records in the database) and automatically generating search criteria (545) for retrieving the data. Embodiments of the present disclosure may analyze data from any number of different sources, including different databases and different records within the same database. Data may be retrieved and analyzed automatically or in response to user input. In some embodiments, data may be collected and analyzed from a list of data sources specified in a rule set retrieved by a software application operating on a computer system (such as computer system 110 in FIG. 1).

Data may be analyzed in any desired manner to achieve any purpose. In some embodiments, data from one data source (e.g., a database) may be compared with data from another data source. For example, a trace table that contains customer requests to find lost packages from one database may be compared to a package table containing descriptions of lost packages from the same or a different database. Based on the combination of values from the two tables, embodiments of the present disclosure may produce a list of probable match results. Likewise, a list of recovered stolen goods may be compared with a list of goods reported stolen to identify probable matches. Embodiments of the present disclosure may be configured to analyze any type of data in any format. For example, photographs or video (e.g. of packages) may be analyzed and/or compared with other image data to help identify and match packages. This may include automatically analyzing, using image processing software, a photograph of a package from one source (such as the sender/addressor of a missing package) with a photograph of a package from another source (such as the shipper or its agent photographing a package having a missing shipping label).

Analysis of the data may also include identifying one or more patterns attributable to the data, while generation of the search criteria may include defining criteria configured to recover data matching the pattern from the same data source or other data sources. Some embodiments may analyze search criteria and results from past searches using such criteria to determine the efficacy of certain criteria, as well as patterns in the previous searches. In this manner, embodiments of the present disclosure may automatically, or in response to user interaction, refine the stored searches to include or exclude criteria in order to make future searches more effective and efficient.

Embodiments of the present disclosure may be configured to flexibly allow users to use and modify search criteria. For example, method 500 further includes the steps of receiving user-defined criteria (550). Such user-defined criteria may be provided by a user through a user interface in communication with a computer system implementing the functionality of method 500. User-defined criteria may also be received via an electronic communication from another computer system, retrieved from a database, or from any other source. Some embodiments may automatically, or in response to user input, duplicate one or more search criteria. The duplicated criteria can then be modified via addition, deletion, and/or editing. Among other things, this allows searches to be replicated and modified without having to entirely recreate the search criteria.

Search criteria may also be received from another source. For example, in some embodiments a shipper or its agent may preemptively flag or otherwise identify one or more packages for a saved search. The saved search may then be automatically or manually run at various points during the handling and delivery of the package to verify the package is being processed as intended. Any defined event (such as an indication that a flagged package was returned to an agent of the shipper responsible for handling problem packages) may trigger an automatic alert to the shipper or other entity to alert that entity as to the package's location and status. In such cases, the saved search can be run at some or all of the defined stages in a shipper's process, such that any deviation from the package's intended course (i.e., it becomes lost, misplaced, or misdirected) will generate the alert. While such searches are particularly useful for expensive or important packages, they may be employed for any package or group of packages to help detect problems with shipments quickly.

Embodiments of the present disclosure may be employed in a variety of applications beyond shipping. For example, some embodiments may be configured for use by law enforcement agencies to identify and locate stolen goods. For example, pawn shops or other stores dealing in second-hand goods may provide a law enforcement agency with pictures, descriptions, identification numbers, and other information for various types of items they receive from customers and clients. The law enforcement agency can then receive automatically generated comparison results for likely or actual matches with goods stolen (e.g., with criteria that compares the data from the pawn shops against the stolen goods database) in order to identify and flag any goods that may be stolen, as well as to generate automatic alerts to law enforcement personnel, the owners of the stolen goods, and/or the pawn shop reporting the information.

Search criteria, whether automatically generated or provided by a user or other system operating in conjunction with embodiments of the disclosure, may be stored (555) in any suitable manner. In some embodiments, the search criteria may be stored in the same database upon which the criteria will be used, though it may be stored in other databases or storage mediums if desired. The search criteria, like all information accessible by embodiments of the present disclosure, may be stored in conjunction with the index table described previously to allow more efficient retrieval and use of the stored searches.

Any type of search criteria may be automatically generated or provided by users or other systems operating in conjunction with embodiments of the disclosure. The search criteria may be in any format and operate with any type of database. In some embodiments, search criteria used in conjunction with identifying and processing problem packages may include one or more of: a characteristic associated with a package, an addressor associated with a package, an addressee associated with a package, and an identifier associated with a package.

Search criteria may include rules for types of data and information to return in a search, as well as rules for exclusions to search results. Search result exclusions may be automatically generated by reviewing the history of past searches as described above, or in response to input from a user. In some embodiments, particular search criteria and/or particular search results can be manually excluded by a user. In some embodiments, a list of included and excluded criteria may be displayed to a user via a display screen of a user interface, with visual indicators denoting the criteria that is included and the criteria that is excluded.

Method 500 further includes retrieving stored search criteria (560) and executing a search of a database using the retrieved search criteria (565). Search criteria may be retrieved and executed automatically by a software program, or semi-automatically or manually in response to user input. In some embodiments, a search of a database using retrieved search criteria may be automatically performed at predetermined intervals.

Results of the executed search may be provided (570) to any entity in any desired format. Search results may be provided by, for example, a computer program operating on a computer system to one or more of: another device via an electronic communication (such as a handheld computing device), a display screen in communication with the computer system, and a printer in communication with the computer system.

Embodiments of the present disclosure not only help maximize the efficiency of users (such as researchers analyzing problem packages), but help increase the speed, accuracy, and repeatability of the searches. This results in a substantial cost savings over conventional methods of searching for shippers and their agents, and allows shippers to provide a much higher level of customer service.

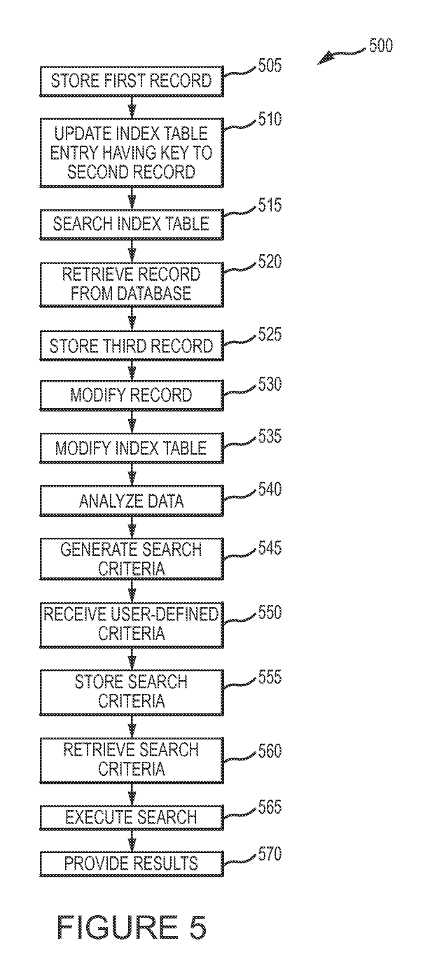

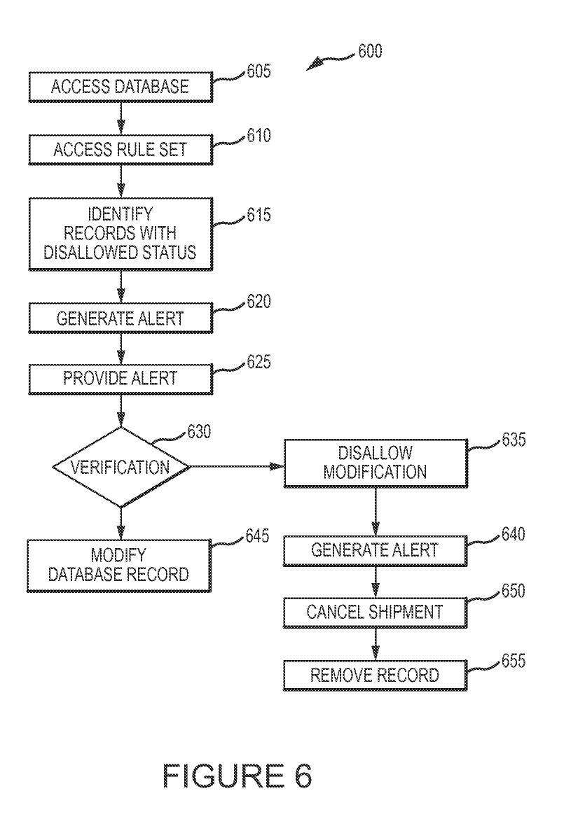

Systems and methods according to aspects of the present disclosure may also be used to help ensure that data utilized in processing packages is correct, and that erroneous data is quickly identified and corrected. Referring now to FIG. 6, exemplary method 600 includes accessing a database (605) having records that include one or more status conditions, accessing a rule set (610) pertaining to the status fields, and identifying (based on the rule set) a record in the database having a disallowed status condition (615).

In some embodiments, database records may have a single (binary) status condition, or they may have multiple status conditions, any of which that may simultaneously be in effect. For example, a status condition related to a problem package may include an indicator as to whether data has been entered for the package, whether the package has been assigned to researcher, whether an owner of the package has been identified, and/or any other desired information.

The rule set may include one or more allowable status conditions (i.e., a white list) for a record. Such rules may be in any format, such as a table of allowable combinations of status conditions, and/or conditional statements defining the allowable conditions. Embodiments of the disclosure can compare the actual status conditions in a record against the allowed conditions and determine if any conditions in a record do not match the allowable conditions. The rule set may also, or alternatively, define one or more disallowed status conditions (i.e., a black list) for a record. In such cases, status conditions matching the disallowed conditions will result in the record being included in an alert (620).

Method 600 additionally includes generating an alert (620) that identifies the record with the disallowed status condition and providing the alert (625). The alert may be provided to a user (e.g., via a display screen of a user interface) or to another entity or device via, for example, any of the electronic communications described previously. The alert may include a list of records having disallowed status conditions, and may include visual indicators (coloring, font, etc.) to particularly point out the condition that is not allowed, as well as a description in the alert (or link thereto) as to why the condition is not allowed. Where a record has multiple status conditions, all such status conditions may displayed in the list, or only the condition(s) that are disallowed may be displayed. Embodiments of the present disclosure quickly and accurately identify erroneous or harmful status conditions and automatically generate alerts so that the errors can be addressed. In some embodiments, the alerts are addressed manually by a human user. In other embodiments, some or all alerts can be automatically addressed by, for example, a software application that automatically corrects erroneous status conditions that are determined to be below a predetermined severity level.

In some embodiments, records containing information for packages in a database may be decoupled from the status conditions for the package. In some embodiments, the status conditions may be stored in other records and/or other databases. In other embodiments, the status conditions for a package may be stored in a status table that is indexed with foreign keys for the package. As actions are performed in the system, the action and/or status change may be updated on the status table, thereby mitigating the need to store any status information on the package record itself. Additionally, status reporting for a package can be performed independently of the conditional state for the package, instead utilizing triggering actions associated with the package

During the processing of packages that encountered issues shipping, it is often desirable to modify information contained within database records at various times. For example, some embodiments may be configured to transfer groups of problem packages from one location to another. Such groups, also known as “transfers” may include individual packages as well as groups of packages contained in a storage unit. Embodiments of the present disclosure help facilitate the accurate and efficient modification of information related to problem packages, including allowing packages to be added and removed from transfer shipments.

Referring again to FIG. 6, method 600 further includes the steps of performing a verification (630) with respect to a requested modification of a database record, and either disallowing the modification (635) and generating an alert (640), or modifying the database record (645). Verification (630) helps ensure that only proper modifications are made to information in a database. Embodiments may verify the identity of an individual, the access rights of an individual, a status condition, a geographical location of a user requesting the modification or of a package, whether the modification is allowed under a rule set, and/or any other information.

For example, some embodiments may disallow the modification if the user requesting the modification does not have sufficient access rights to modify the record, if the user is not located in same facility as a group of packages being modified, if a package being added or removed is not at the same location as the group of packages being modified, and/or if the group of packages includes only a single package and the modification is attempting to remove the last package. If the verification is not successful, embodiments of the disclosure may block the modification (635) and generate an alert (640) in any suitable manner, including those described for other alerts described previously.

In some cases, the alert may contain information regarding the failed verification and a suggested course of action for a user to take. In other embodiments, the course of action may automatically be performed (e.g., by a software application). For example, where a group of packages includes a single package, and a request to modify the record associated with the group includes deleting the last package from the group, the verification (630) may fail, the modification blocked (635), and an alert generated (640) that indicates that the shipment should be cancelled by the user instead. Alternatively, or in addition to the alert, the system may automatically cancel the shipment (650) in response to the request and remove the record (655) associated with the shipment or group of packages from the database.

The particular implementations shown and described above are illustrative of the exemplary embodiments and their best mode and are not intended to otherwise limit the scope of the present disclosure in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the present disclosure. Furthermore, the connecting lines shown in the various figures are intended to represent exemplary functional relationships and/or physical couplings between the various elements. Many alternative or additional functional relationships or physical connections may be present in a practical system.

The term “non-transitory” is to be understood to remove only propagating transitory signals from the claim scope and does not relinquish rights to all standard computer-readable media. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims.

No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements may include other elements not expressly listed or inherent to such process, method, article, or apparatus.

What is claimed is:

1. A method performed by a computer program operating on a computer system, the method comprising:
storing, by the computer system, a first record in a database in communication with the computer system, the first record including a first key associated with the first record, and a second key associated with a second record stored in the database;
updating, by the computer system, an entry in an index table, wherein the entry includes the second key associated with the second record, and updating the entry includes adding at least a portion of the first key to the entry.

2. The method of claim 1, further comprising:
searching, by the computer system, the index table using at least a portion of the second key; and
retrieving, by the computer system, the first record from the database based on the entry in the index table.

3. The method of claim 1, further comprising:
searching, by the computer system, the index table using at least a portion of the first key; and
retrieving, by the computer system, the second record from the database based on the entry in the index table.

4. The method of claim 1, wherein the entry in the index table further includes reference information related to a second database record, and wherein updating the entry includes adding reference information related to the first database record to the entry in the index table.

5. The method of claim 1, wherein one or more of the first key and the second key include an identifier selected from the group consisting of:
an identifier for a storage location;
an identifier for a storage unit within a storage location;
an identifier for a package processing station; and
an identifier for a package.

6. The method of claim 5, wherein the second key includes an identifier for a storage location, and the first key includes an identifier for a storage unit within the storage location.

7. The method of claim 6, further comprising:
storing, by the computer system, a third database record in the database, the third record having a third key that includes an identifier for a package that is stored in the storage unit within the storage location; and
updating, by the computer system, the entry in the index table, wherein updating the entry includes adding at least a portion of the third key to the entry.

8. The method of claim 1, further comprising:
modifying, by the computer system, the first database record; and
modifying, by the computer system, the entry in the index table to reflect the modification to the first database record.

9. The method of claim 8, wherein modifying the entry in the index table is performed synchronously.

10. The method of claim 8, wherein modifying the entry in the index table is performed asynchronously.

11. The method of claim 1, further comprising:
analyzing, by the computer system, data from one or more records in the database;
automatically generating, by the computer system, search criteria for retrieving the data; and
storing the search criteria in the database.

12. The method of claim 11, further comprising:
retrieving, by the computer system, the stored search criteria from the database; and
executing a search of the database using the search criteria.

13. The method of claim 12, wherein the search of the database is executed automatically at a predetermined interval.

14. The method of claim 12, further comprising providing, by the computer system, results of the executed search, wherein providing the search results includes presenting the results via one or more of an electronic communication to another device, a display screen in communication with the computer system, and a printer in communication with the computer system.

15. The method of claim 11, further comprising:
receiving, by the computer system, input from a user via a user interface, the input containing user-defined search criteria; and
storing the user-defined search criteria in the database.

16. The method of claim 15, further comprising:
duplicating, by the computer system, one or more of the automatically generated search criteria and the user-defined search criteria;
modifying the duplicated search criteria; and
storing the modified duplicated search criteria.

17. The method of claim 11, wherein the search criteria includes one or more of: a characteristic associated with a package, an addressor associated with a package, an addressee associated with a package, and an identifier associated with a package.

18. The method of claim 11, wherein analyzing the data from the database includes comparing the data from the database to data from another database.

19. The method of claim 11, wherein analyzing the data from the database includes identifying, by the computer system, a pattern attributable to a plurality of records in the database, and wherein generating the search criteria includes defining criteria configured to recover data matching the identified pattern.

20. A tangible non-transitory computer-readable medium having instructions stored thereon, that, in response to execution by a processor, cause the processor to perform operations comprising:
storing a first record in a database in communication with the computer system, the first record including a first key associated with the first record, and a second key associated with a second record stored in the database;
updating an entry in an index table, wherein the entry includes the second key associated with the second record, and updating the entry includes adding at least a portion of the first key to the entry.

21. A system comprising:
a database; and
a computer system in communication with the database, the computer system comprising:
a processor; and
a tangible, non-transitory memory coupled to the processor and storing instructions that, in response to execution by the processor, cause the processor to perform operations comprising:
storing a first record in the database, the first record including a first key associated with the first record, and a second key associated with a second record stored in the database;
updating an entry in an index table, wherein the entry includes the second key associated with the second record, and updating the entry includes adding at least a portion of the first key to the entry.
